(19) United States
(12) Patent Application Publication
(10) Pub. No.: US 2010/0132665 A1
(43) Pub. Date: Jun. 3, 2010

(54) Method for Controlling as well as Method for Reducing Engine Speed

(75) Inventors: Johann Graf, Hausen (DE); Frank Mueller, Ingolstadt (DE)

Correspondence Address: Novak Druce & Quigg LLP, 1300 I Street NW, Suite 1000 West Tower, Washington, DC, 20005, US

(73) Assignee: Audi AG, Ingolstadt (DE)

(21) Appl. No.: 12/622,009

(22) Filed: Nov. 19, 2009

(30) Foreign Application Priority Data
Nov. 19, 2008 (DE) 10 2008 057 923.8

(51) Int. Cl. F02D 41/00

(52) U.S. Cl. 123/350

(57) ABSTRACT

The motion of a piston in an engine is braked, for example, within the scope of a method for controlling the engine speed, in that ignition takes place prior to a predetermined optimum ignition point. In this way, more than half of the fuel burns before the piston reaches top dead center. Thus, before the actual stroke of performing work, the motion of the piston is opposed and the piston and thus the crankshaft are braked.

The invention relates to a method for controlling engine speed, its being assumed that the engine repeatedly passes through a cycle, that in the cycle fuel is delivered into the piston chamber, and that this fuel is ignited at an ignition point which is defined in the cycle. The ignition point can also be specified as the ignition angle, the size of the angle being moved to the position of the piston moving in the piston chamber. The invention relates in particular to the aspect of how the engine speed can be reduced.

### THE BACKGROUND OF THE INVENTION

The speed can be changed by the acting torque. The latter is dependent on the filling of the piston chamber (cylinder) and the ignition point, also dictated by the injection amount. A change of the torque is necessary based on the speed requirements by the automatic transmission of a motor vehicle, an idle speed controller, etc.

It is relatively easy to increase the torque since a plurality of potential influences are available in this respect. It is relatively difficult to reduce the engine speed quickly enough. Due to the mechanical inertia of the engine components, generally, the speed is only reduced as a result of friction and the action of ancillary units.

Thus, in a typical motor vehicle, for example, the Audi 3.0 TDI, at 3000 rpm a positive moment of +550 Nm opposes an available loss torque of −60 Nm. To increase the speed, a torque range from 0 Nm to 490 Nm, that is, up to 550 Nm-60 Nm is available. To reduce the speed, only a loss torque of 0 Nm to 60 Nm is available.

The speed can overshoot relatively quickly, however, a speed overshoot can only be corrected slowly. Nor can the system dictate that the speed diminishes relatively quickly, to date there has been no possibility for quickly reducing the speed.

DE 10 2004 002 011 A1 describes speed control in which the engine is operated lean. By changing the fuel composition, the speed can be changed relatively quickly, specifically can be increased by the engine being operated less leanly and can be reduced by the engine being operated more leanly. For a reduction, at the same time ignition is later than otherwise.

Not every motor vehicle is suitable for lean operation of its engine. Even with such a suitability this is not the case under all possible conditions. In the present case, it should be possible to reduce the engine speed relatively quickly when the engine is being operated with a non-lean fuel-air mixture, in particular with an air-fuel ratio λ=1 (at least on average).

U.S. Pat. No. 5,036,802 discloses for a two-stroke engine changing from forward operation to reverse operation by preventing, for a transition time, the ignition of fuel so that the engine speed is reduced as a result of friction. For a low speed then ignition takes place as if the engine were already in reverse operation. Reverse operation is then imposed on the engine proceeding from forward operation by ignition.

The object of the invention is to devise a method for controlling the engine speed of the initially described type by means of which the engine speed is promptly matched to the requirements and by means of which engine overshoots are promptly corrected. According to another aspect of the invention a method for reducing the engine speed is thus designed to be made available.

### SUMMARY OF THE INVENTION

In the method according to the invention, before conventional normal operation, the step must be carried out that an optimum ignition point is determined in the cycle which the engine is passing through, the optimum ignition point under otherwise the same conditions being that ignition point at which ignition of the fuel causes delivery of maximum output by the engine under otherwise the same conditions.

In normal operation then the actual engine speed is recorded and compared to a setpoint engine speed, and the setpoint engine speed can be dictated by a unit which can induce a relatively quick change of the setpoint engine speed.

If the actual engine speed is now greater than the setpoint engine speed and the engine speed must therefore be reduced, the fuel which still is delivered into the piston chamber in each cycle is ignited at the ignition point prior to the optimum ignition point in at least one cycle, specifically directly after ascertaining that the actual engine speed is greater than the setpoint minimum engine speed, this advanced ignition preferably being repeated as long as the actual engine speed is greater than the setpoint engine speed.

The invention is based on the finding that the progression of the combustion process when the optimum ignition point is chosen is such that the crucial point of combustion is shortly after the instant at which the piston moving in the cylinder is at its top dead center. The crucial point of combustion is the instant at which half the fuel is burned. The optimum ignition point is prior to the piston's reaching top dead center. If, at this point, ignition takes place distinctly before the optimum ignition point, more than half the fuel is burned before the piston reaches top dead center. This means that the resulting gas which afterwards tries to expand acts against the movement of the piston and since the proportion of the fuel which is burned after reaching top dead center is less than half, there is less gas which positively accelerates the piston than gas which brakes (negatively accelerates) the piston. With this a braking moment is applied to the entire engine system, particularly the crankshaft. Thus, braking becomes active. The measure according to the invention therefore makes available a negative torque beyond friction. Control thus can take place more quickly than in the past when the engine speed must be reduced.

In the control method according to the invention, in the case in which the actual engine speed is less than or equal to the engine speed, the fuel can be ignited conventionally at the optimum ignition point in at least one cycle. Then the engine speed is not increased by changing the ignition point relative to the optimum ignition point.

In the method according to the invention for reducing the speed of an engine which repeatedly passes through a cycle, in the cycle fuel being delivered into the piston chamber of the engine in which a piston moves back and forth, the fuel according to the invention is ignited at the instant in the cycle such that the forces, which have been applied to the piston during the subsequent ignition process and which brake its motion, act more strongly overall than the forces which have been applied to the piston and which accelerate its motion during the combustion process. The concept of “acting” in this connection entails making available braking energy on the one hand and acceleration energy on the other.

The engine speed in the method according to the invention is therefore reduced by the fuel itself. It is a finding of this invention that the fuel itself can be used for braking.

As already described above, the ignition point for the fuel of the type desired for reducing the engine speed is characterized in that the fuel is ignited early enough in the cycle of reciprocating motion of the piston so that before reaching the reversal point of the piston more than half of the fuel is burned in the same cycle.

The invention is intended preferably for spark ignition engines (four-stroke engines). In such engines the piston travels to the same reversal point (e.g., top dead center) twice in each cycle.

### BRIEF DESCRIPTION OF THE DRAWING

FIG. 1 schematically shows the steps of a method according to the invention for controlling the engine speed.

### DETAILED DESCRIPTION OF THE PREFERRED EMBODIMENTS OF THE INVENTION

It is assumed here that the speed of a spark ignition engine is to be controlled. In the course of operation a setpoint for the engine speed is continuously made available, for example, by the speed requirement of an automatic transmission, an idle speed controller, etc.

For a predefined spark ignition engine for predetermined conditions an optimum ignition point can be defined in the engine cycle. As is recognized, the engine passes through the four strokes of intake, in which an ignitable fuel-air mixture is formed in the intake channel or directly in the cylinder by injecting fuel, compression of the fuel-air mixture, performing work as a result of the combustion of the fuel, and discharge. The condition for performing work is that the fuel-air mixture is ignited. The working step conventionally begins at so-called top dead center of the piston in the cylinder. The optimum ignition point is generally prior to reaching this top dead center. For a given spark ignition engine under different, otherwise given conditions, the respective optimum ignition point can be defined. It is that instant in the cycle to which it applies that upon ignition at it, the maximum amount of energy (under given conditions) is transmitted to the piston and thus to the crankshaft. The ignition point t can be given as a quantity with 0<t<T, T being the length of the period of the cycle. The latter can be regarded as the plotting of the angle (ignition angle) onto the time scale, in particular when the piston uniformly traverses the positions which define the angle.

In this process, as shown in step S10, the optimum ignition point can be determined conventionally. The concept of “optimum ignition point,” in this connection, should be referenced to the ambient conditions. Thus, in practical applications the entire characteristic or family of characteristics (an ignition map) of ignition points is in fact determined, there being a dependency for predetermined parameters, for example the amount of fuel injected or the air-fuel ratio, or the like. Any reference to the optimum ignition point below should be understood such that the respective optimum ignition point which is defined under the conditions prevailing at the time is referred to.

In the method according to the invention, fundamentally, according to step S12, the engine is operated such that the fuel-air mixture is ignited at the optimum ignition point. Then the power output of the engine is maximum. During normal operation, according to step S14, the engine speed is continuously measured. The actual engine speed is compared to a setpoint for the engine speed.

Based on this comparison, the result, according to step S16, may be that the speed need not be changed. In exactly the same manner, a higher speed can be required than is currently prevailing. In both cases, according to step S16, the engine continues to be operated such that ignition takes place each time at the optimum ignition point (S12).

It is somewhat different when, according to step S18, a lower speed is required. Then, there is a transition from step S12 to step S20: The ignition point is advanced compared to the optimum ignition point. This means that the combustion process proceeds such that more than half the fuel bums before the piston reaches top dead center. Thus, not all the fuel is used to carry out the working stroke. Rather, the fuel in the previous stroke of compression at the same time effects “counter-working:” The combustion process causes a force to be applied against the motion of the piston, i.e., away from top dead center when the piston is moving toward top dead center. In other words, the piston is braked, the crankshaft experiences a braking moment and the speed is reduced as desired, in fact very quickly.

During execution of step S20, step S14 still takes place, here designated as S14′, because it relates to step S20 instead of to step S12. As long as, according to step S18′, low speed is required as measured, step S20 is continued, i.e., the engine is further braked by ignition taking place prior to the optimum ignition point. But as soon as the desired speed has been reached, or even a higher speed is again required (step S18′), a change is made from step S20 back to step S12 again, i.e., the engine is now operated again such that the air-fuel mixture is operated at the optimum ignition point.

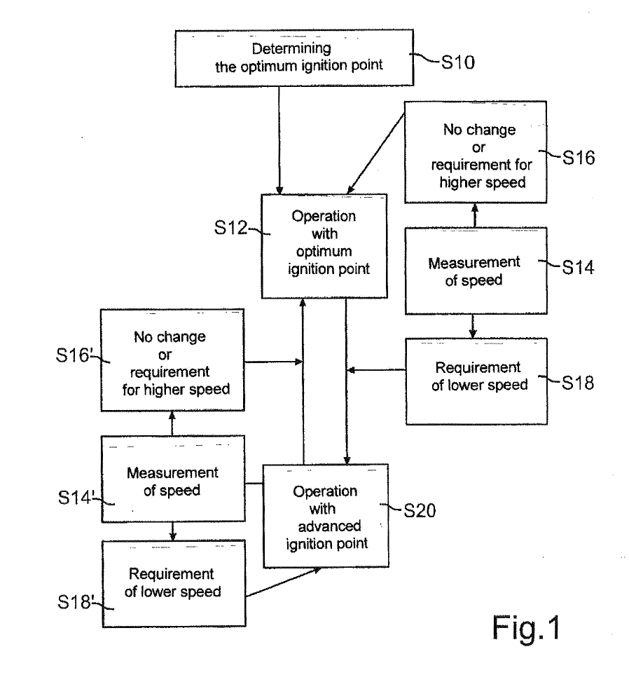

FIG. 1 is used only for illustration of when which ignition point is chosen. So that control takes place completely, parameters other than the ignition point can also be varied. In particular, when an increase of speed is required, a further measure can take place, such as, for example, increased fuel supply.

The method according to the invention can be used especially advantageously in spark ignition engines, but basically also for other engine types.

1. A method for controlling the speed of an engine which repeatedly passes through a cycle, in which fuel is delivered into the piston chamber and is ignited at the ignition point in the cycle, comprising:
determining an optimum ignition point in the cycle, the optimum ignition point under predetermined conditions being that ignition point at which ignition of the fuel causes the delivery of maximum output under predetermined conditions by the engine,
detecting the actual engine speed under normal operating conditions; it to
comparing the actual engine speed with a set point engine speed; and
igniting the fuel at the ignition point before the optimum ignition point in at least one cycle if the actual engine speed is greater than the set point engine speed.

2. The method for controlling engine speed according to claim 1, wherein if the actual engine speed is less than or equal to the setpoint engine speed, the fuel is ignited in at least one cycle at the optimum ignition point.

3. The method for reducing the speed of an engine which repeatedly passes through a cycle, in which the fuel is delivered into the piston chamber of the engine in which a piston moves back and forth, and the fuel is ignited at the instant in the cycle such that the forces which have been applied to the piston during the subsequent ignition process and which brake its motion act overall more strongly than the forces which have been applied to the piston during the combustion process and which accelerate its motion.

4. The method according to claim 3, in which the fuel is ignited early enough in the cycle of back and forth motion of the piston that before reaching the reversal point of the piston more than half the fuel is already burned in the same cycle.

5. The method according to claim 1 wherein the method is used in a spark ignition engine.
